(19) United States
(12) Patent Application Publication
(10) Pub. No.: US 2026/0268749 A1
(43) Pub. Date: Sep. 10, 2026

(54) ROBOTIC PATROL DEVICE

(71) Applicant: Craig Bryan, Mesa, AZ (US)

(72) Inventor: Craig Bryan, Mesa, AZ (US)

(21) Appl. No.: 19/071,909

(22) Filed: Mar. 6, 2025

(51) Int. Cl. G08B 13/18; B60K 1/02; B60L 50/60; B60L 53/16; G05D 1/639; G05D 1/689; G05D 105/80; G05D 105/85; G05D 107/60; G08B 17/10; G08B 27/00

(52) U.S. Cl. CPC G08B 13/18; B60K 1/02; B60L 50/60; B60L 53/16; G05D 1/639; G05D 1/689; G08B 17/10; G08B 27/001; G05D 2105/85; G05D 2105/89; G05D 2107/60

(57) ABSTRACT

A robotic patrol device includes a drive platform and a plurality of wheels rotatably coupled to the drive platform to roll along a support surface. A dome is removably coupled to the drive platform and a smoke detector is coupled to the dome to detect smoke in the building. A water detector is coupled to the drive platform to detect water in the building and a heat detector is coupled to the dome to detect heat in the building. A plurality of motion sensors is coupled to the dome to sense motion in the building. A transceiver is coupled to the dome to broadcast an alert signal to an extrinsic communication network for alerting emergency responders to a potential emergency in the building.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to patrol devices and more particularly pertains to a new patrol device for patrolling a building under construction while the building is unoccupied. The device includes a drive platform and a plurality of wheels rotatably coupled to the drive platform and plurality of motors coupled to the drive platform which drives the plurality of wheels. The device includes a dome that is removably coupled to the drive platform and a smoke detector attached to the dome and a heat detector attached to the dome and a plurality of motion detectors attached to the dome. The device includes a water sensor attached to the drive platform and a camera attached to the dome and a transceiver attached to the drive platform to alert emergency responders in the event of an emergency.

### (2) Description of Related Art Including Information Disclosed Under 37 CFR 1.97 and 1.98.

The prior art relates to patrol device including: a variety of robotic fire detection devices that each at least includes an autonomous robotic unit and a fire detection device attached to the autonomous robotic unit to detect a fire in a building; a variety of robotic surveillance devices that each at least includes an autonomous robotic unit and a camera mounted to the autonomous robotic unit for conducting surveillance of an area; a robotic security device that includes an autonomous robotic unit and an RFID scanner to scan RFID tags in a retail environment. In no instance does the prior art disclose a robotic patrol device that includes an autonomous robotic unit for patrolling a construction site and a smoke detector and a heat detector and a camera and a water detector and a plurality of motion detectors and a transceiver which alerts emergency responders to a potential emergency at the construction site.

### BRIEF SUMMARY OF THE INVENTION

An embodiment of the disclosure meets the needs presented above by generally comprising a drive platform and a plurality of wheels rotatably coupled to the drive platform to roll along a support surface. A dome is removably coupled to the drive platform and a smoke detector is coupled to the dome to detect smoke in the building. A water detector is coupled to the drive platform to detect water in the building and a heat detector is coupled to the dome to detect heat in the building. A plurality of motion sensors is coupled to the dome to sense motion in the building. A transceiver is coupled to the dome to broadcast an alert signal to an extrinsic communication network for alerting emergency responders to a potential emergency in the building.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a right side view of a robotic patrol device according to an embodiment of the disclosure.

FIG. 2 is a front view of an embodiment of the disclosure.

FIG. 3 is a top view of an embodiment of the disclosure.

FIG. 4 is an exploded back view of an embodiment of the disclosure.

FIG. 5 is a schematic view of an embodiment of the disclosure.

### DETAILED DESCRIPTION OF THE INVENTION

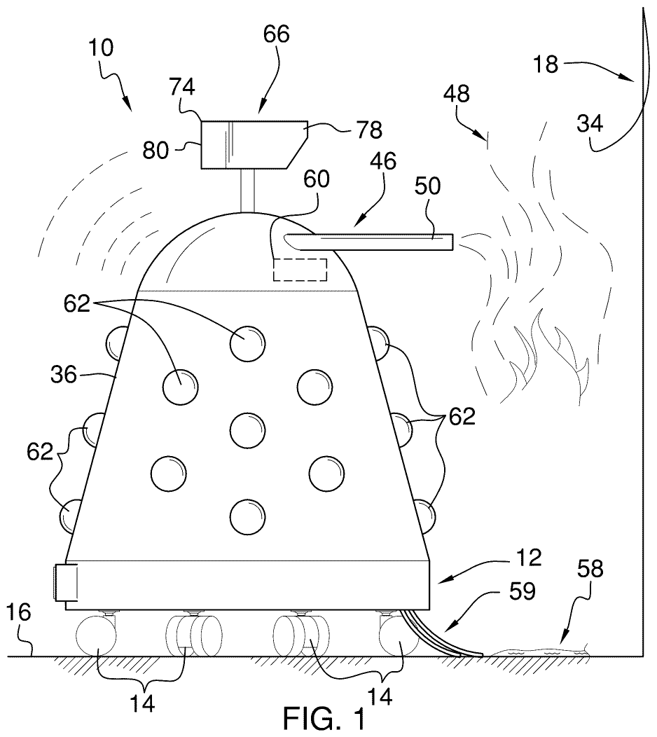

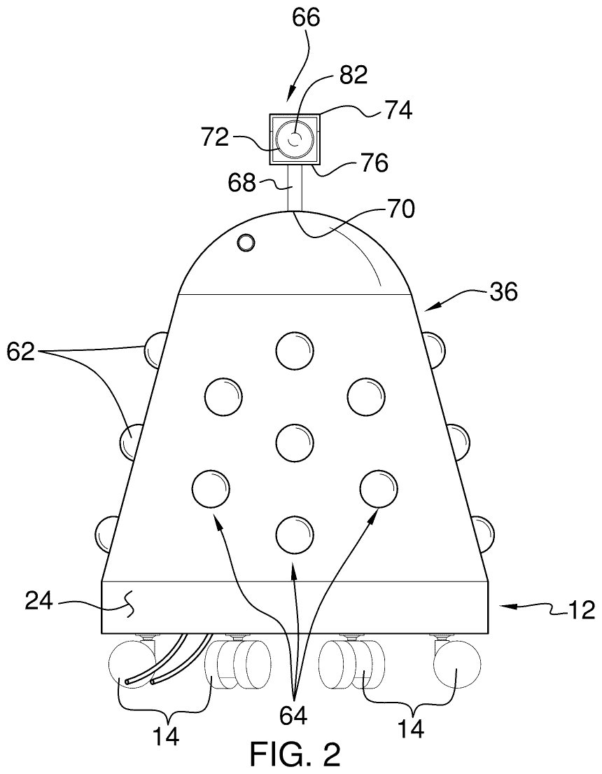

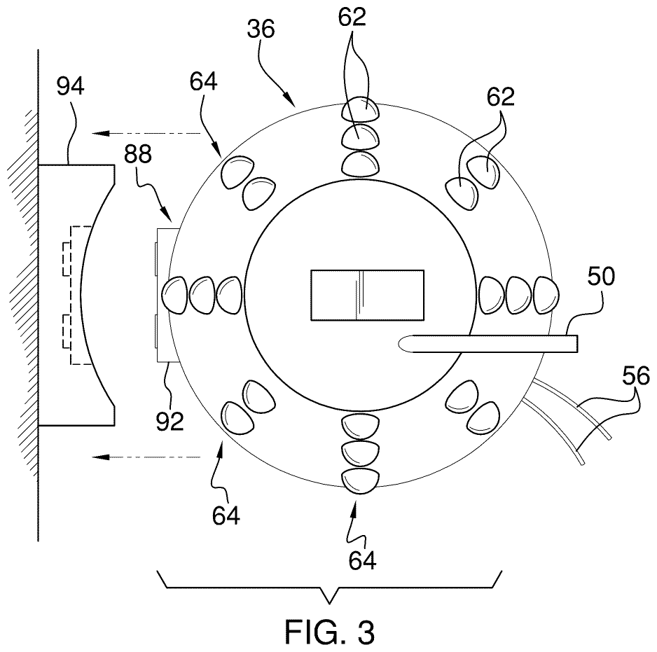

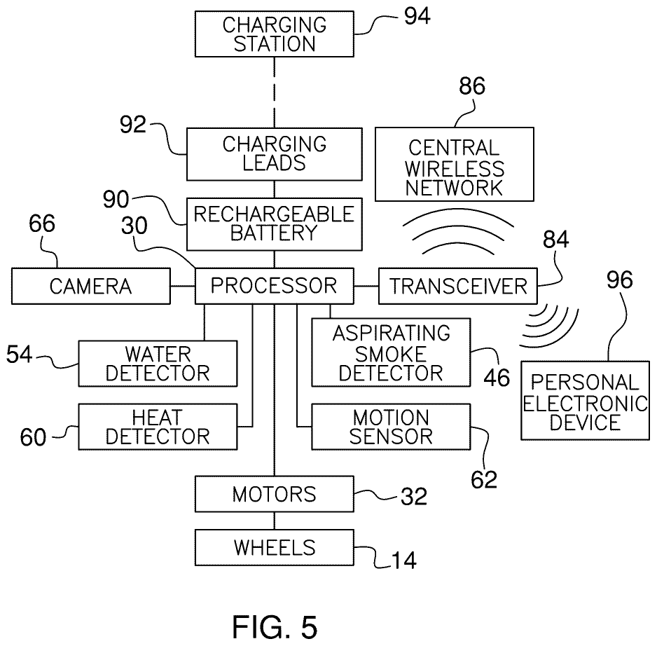

With reference now to the drawings, and in particular to FIGS. 1 through 5 thereof, a new patrol device embodying the principles and concepts of an embodiment of the disclosure and generally designated by the reference numeral 10 will be described.

As best illustrated in FIGS. 1 through 5, the robotic patrol device 10 generally comprises a drive platform 12. A plurality of wheels 14 is each rotatably coupled to the drive platform 12 such that the plurality of wheels 14 can roll along a support surface 16. The support surface 16 may be a floor of a building 18 or other type of horizontal support surface. The building 18 may be a commercial building that is currently under construction and is unoccupied when construction workers are not present in the building 18.

The drive platform 12 has a lower surface 20 and an upper surface 22 and a perimeter surface 24 extending between the lower surface 20 and the upper surface 22. The perimeter surface 24 is continuously arcuate about a center of the drive platform 12 such that the drive platform 12 has a disk shape. Furthermore, the drive platform 12 resists becoming entrapped in a corner, for example, in the building 18 in which the drive platform 12 is placed. Each wheel 14 of the plurality of wheels 14 is disposed on the lower surface 20 of the drive platform 12 such that the drive platform 12 is supported above the support surface 16. The plurality of wheels 14 is evenly spaced apart from each other and is distributed around a full circumference of the lower surface 20.

The plurality of wheels 14 include a pivot 26 that is pivotally attached to the lower surface 20 of the drive platform 12 and a pair of rollers 28 that each rotatably attached to the pivot 26. The pivot 26 associated with a respective wheel 14 is rotatable about an axis extending through the upper surface 22 and the lower surface 20 of the drive platform 12. Furthermore, the pair of rollers 28 associated with the respective wheel 14 has a rotational axis that is oriented perpendicular to the axis extending through the upper surface 22 and the lower surface 20 of the drive platform 12.

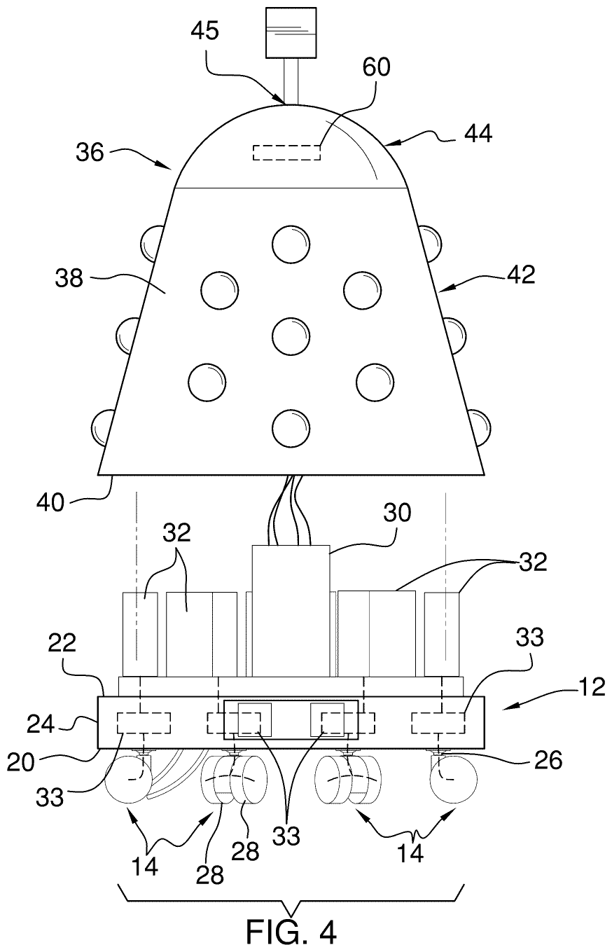

A processor 30 is coupled to the drive platform 12 and a plurality of motors 32 is provided and each motor 32 of the plurality of motors 32 is coupled to the drive platform 12. Each motor 32 of the plurality of motors 32 is in electrical communication with the processor 30 and each motor 32 of the plurality of motors 32 is in mechanical communication with a respective one of the plurality of wheels 14. A respective one of the plurality of motors 32 rotates the respective one of the plurality of wheels 14 when the respective one of the plurality of motors 32 is turned on. The rotation of the wheels 14 enables the drive platform 12 to travel around the building 18. Furthermore, the plurality of motors 32 rotate each wheel 14 of the plurality of wheels 14 independently of each other to steer the drive platform 12 in the building 18. As is shown in FIG. 4, a plurality of drive units 33 may be included which are each integrated into the drive platform 12 and which are each in mechanical communication between a respective one of the plurality of motors 32 and a respective one of the plurality of wheels 14. Furthermore, each drive unit 33 of the plurality of drive units 33 may comprise a series of gears and a series of drive shafts or a belt drive or other type of mechanical drive unit that is capable of transmitting rotational torque of the respective motor 32 to the pivot 26 of the respective wheel 14 as well as to the pair of rollers 28 of the respective wheel 14.

The processor 30 detects when any of the plurality of motors 32 encounter resistance to rotating. Furthermore, the processor 30 actuates the plurality of motors 32 to change direction of rotation when the processor 30 detects that any of the plurality of motors 32 encounters resistance to rotating. Additionally, the plurality of motors 32 drive the drive platform 12 away from an obstacle 34 in the building 18 when the drive platform 12 abuts against the obstacle 34. The obstacle 34 might be a wall in the building 18, furniture in the building 18 or any other object that impedes the movement of the drive platform 12.

A dome 36 is provided and the dome 36 is removably coupled to the drive platform 12. The dome 36 has an outer wall 38 and the outer wall 38 has a bottom edge 40 and the bottom edge 40 is removably attachable to the upper surface 22 of the drive platform 12. The outer wall 38 curves upwardly from the upper surface 22 of the drive platform 12 when the bottom edge 40 is removably attached to the upper surface 22 of the drive platform 12. The outer wall 38 of the dome 36 has a planar portion 42 extending upwardly from the bottom edge 40 of the dome 36 and the outer wall 38 has a curved portion 44 extending between the planar portion 42 and an apex 45 of the dome 36. The planar portion 42 angles inwardly between the bottom edge 40 and the curved portion 44 such that the dome 36 has a frusto-conical shape.

A smoke detector 46 is coupled to the dome 36 and the smoke detector 46 is in electrical communication with the processor 30. The smoke detector 46 communicates a smoke alert to the processor 30 when the smoke detector 46 is actuated to alert the processor 30 that the smoke detector 46 has detected smoke 48 in the building 18. Furthermore, the processor 30 is actuated to perform an alert sequence when the processor 30 receives the smoke alert. The smoke detector 46 includes an intake pipe 50 that is coupled to the curved portion 44 of the outer wall 38 of the dome 36. The intake pipe 50 extends outwardly from the curved portion 44 of the outer wall 38 such that the intake pipe 50 is in fluid communication with ambient air in the building 18 to receive the smoke 48 in the ambient air in the building 18. Additionally, the intake pipe 50 is located closer to the apex 45 of the dome 36 than the planar portion 42 of the outer wall 38 of the dome 36. The smoke detector 46 may be an aspirating electronic smoke detector 46 of any conventional design that might commonly be employed in either residential structures or commercial structures.

A water detector 54 is coupled to the drive platform 12 and the water detector 54 is in electrical communication with the processor 30. The water detector 54 communicates a water alert to the processor 30 when the water detector 54 is actuated to alert the processor 30 that the water detector 54 has detected water in the building 18. Furthermore, the processor 30 is actuated to perform the alert sequence when the processor 30 receives the water alert. The water detector 54 includes plurality of sensing lines 56 and each sensing line 56 of the plurality of sensing lines 56 is coupled to and extends downwardly from the lower surface 20 of the drive platform 12. Furthermore, each sensing line 56 of the plurality of sensing lines 56 is in physical contact with the support surface 16 such that the plurality of sensing lines 56 can sense when water 58 is encountered on the support surface 16. Each sensing line 56 of the plurality of sensing lines 56 may be comprised of an electrically conductive material that are placed in electrical communication with the water 58 when the plurality of sensing lines 56 encounters the water 58. Furthermore, the processor 30 may determine the change of resistance between the plurality of sensing lines 56 once the plurality of sensing lines 56 makes contact with the water 58.

A heat detector 60 is coupled to the dome 36 and the heat detector 60 is in electrical communication with the processor 30. The heat detector 60 communicates a heat alert to the processor 30 when the heat detector 60 is actuated to alert the processor 30 that the heat detector 60 has detected heat in the building 18. The processor 30 is actuated to perform the alert sequence when the processor 30 receives the heat alert. The heat detector 60 is integrated into the outer wall 38 of the dome 36 such that the heat detector 60 is in communication with the ambient air in the building 18. The heat detector 60 may comprise an infrared heat detector or other type of electronic heat detector that is commonly employed in fire detection system 68s.

A plurality of motion sensors 62 is provided and each motion sensor 62 of the plurality of motion sensors 62 is coupled to the dome 36 such that each motion sensor 62 of the plurality of motion sensors 62 can sense motion in the building 18. Each motion sensor 62 of the plurality of motion sensors 62 is in electrical communication with the processor 30. Furthermore, respective ones of the plurality of motion sensors 62 communicates a motion alert to the processor 30 when the respective ones of the plurality of motion sensors 62 is actuated. The respective ones of the plurality of motion sensors 62 alert the processor 30 that the respective ones of the plurality of motion sensors 62 has sensed motion in the building 18. Additionally, the processor 30 is actuated to perform the alert sequence when the processor 30 receives the motion alert.

The plurality of motion sensors 62 is arranged in a plurality of columns 64 on the outer wall 38 of the dome 36. Each column 64 of the plurality of columns 64 extends along a line which extends between the apex 45 of the dome 36 and the bottom edge 40 of the dome 36. Additionally, the plurality of columns 64 is evenly spaced apart from each other and is distributed around a full circumference of the outer wall 38. Each motion sensor 62 of the plurality of motion sensors 62 may comprise an infrared motion sensor or any other type of electronic motion sensor that has an operational sensitivity ranging between approximately 100.0 meters and 200.0 meters.

A camera 66 is coupled to the dome 36 to capture imagery of the building 18. Additionally, the camera 66 is in electrical communication with the processor 30. The camera 66 includes a stem 68 which has a bottom end 70 that is coupled to the outer wall 38 of the dome 36. The stem 68 is located on the apex 45 of the dome 36 and the stem 68 has a top end 72. The camera 66 includes a housing 74 that has a bottom wall 76 which is coupled to the top end 72 of the stem 68.

The housing 74 has a front end 78 and a back end 80; the housing 74 is oriented such that a line extending between the front end 78 and the back end 80 is oriented parallel to the upper surface 22 of the drive platform 12 such that the front end 78 is directed toward an interior of the building 18. The camera 66 includes a lens 82 which is coupled to the front end 78 of the housing 74 to pass light into the housing 74. The processor 30 is in communication with the lens 82 such that the processor 30 is receives the imagery of the building 18 from the light that passes through the lens 82. Furthermore, the processor 30 may employ imagery captured by the camera 66 to assist the processor 30 with object detection and avoidance.

A transceiver 84 is coupled to the dome 36 and the transceiver 84 is in communication with the processor 30. The transceiver 84 is actuated to broadcast an alert signal when the processor 30 performs the alert sequence. Furthermore, the transceiver 84 is in wireless communication with an extrinsic communication network 86, including but not being limited to a cellular phone network, the internet or other type of wireless global communication system. Consequently, the transceiver 84 can communicate the alert signal to emergency responders such that the emergency responders can respond to a potential emergency in the building 18. The transceiver 84 may comprise a radio frequency transceiver or the like and the transceiver 84 may employ a WPAN signal, a cellular phone signal or other type of communication protocol that is specific to the extrinsic communication network 86.

A power supply 88 is coupled to the drive platform 12 and the power supply 88 is in electrical communication with the processor 30. The power supply 88 comprises a rechargeable battery 90 that is coupled to the upper surface 22 of the drive platform 12 and the rechargeable battery 90 is in electrical communication with the processor 30. The power supply 88 includes a charging port 92 which is coupled to the perimeter surface 24 of the drive platform 12. The charging port 92 can be electrically mated with a charging dock 94 when the drive platform 12 is steered toward the charging dock 94. Furthermore, the charging port 92 is in electrical communication with the rechargeable battery 90 for charging the rechargeable battery 90. The charging dock 94 may broadcast a tracking signal that is received by the transceiver 84 which the processor 30 may employ to automatically guide the drive platform 12 into the charging dock 94. Additionally, a personal electronic device 96, including but not being limited to a smartphone or the like, may be synchronized with the transceiver 84 to program operating hours and communication instructions for contacting the emergency responders and other operational parameters into the processor 30.

In use, the drive platform 12 is positioned in the building 18 during the construction phase of the building 18 and the operational parameters are programmed into the processor 30 with the personal electronic device 96. The plurality of motors 32 rotate the plurality of wheels 14 to drive the drive platform 12 and the dome 36 around the building 18 during nighttime hours, for example, or other occasions when the building 18 will be unoccupied. Furthermore, the transceiver 84 will broadcast the alert signal to the extrinsic communication network 86 in the event that the processor 30 performs the alert sequence. Thus, the building 18 can be monitored for a fire or a water leak or an unusual heat source or motion of an intruder without the need for a human security guard. The drive platform 12 will return to the charging dock 94 at the end of the operating hours each day to recharge the rechargeable battery 90.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A robotic patrol device for detecting smoke or water or intruders in an unoccupied building, said device comprising:
a drive platform;
a plurality of wheels, each wheel of said plurality of wheels being rotatably coupled to said drive platform wherein said plurality of wheels is configured to roll along a support surface;
a processor being coupled to said drive platform;
a plurality of motors, each motor of said plurality of motors being coupled to said drive platform, each motor of said plurality of motors being in electrical communication with said processor, each motor of said plurality of motors being in mechanical communication with a respective one of said plurality of wheels, a respective one of said plurality of motors rotating said respective one of said plurality of wheels when said respective one of said plurality of motors is turned on wherein said drive platform is configured to travel around the building;
a dome being removably coupled to said drive platform;
a smoke detector being coupled to said dome, said smoke detector being in electrical communication with said processor, said smoke detector communicating a smoke alert to said processor when said smoke detector is actuated wherein said smoke detector is configured to alert said processor that said smoke detector has detected smoke in the building, said processor being actuated to perform an alert sequence when said processor receives said smoke alert;
a water detector being coupled to said drive platform, said water detector being in electrical communication with said processor, said water detector communicating a water alert to said processor when said water detector is actuated wherein said water detector is configured to alert said processor that said water detector has detected water in the building, said processor being actuated to perform said alert sequence when said processor receives said water alert;
a heat detector being coupled to said dome, said heat detector being in electrical communication with said processor, said heat detector communicating a heat alert to said processor when said heat detector is actuated wherein said heat detector is configured to alert said processor that said heat detector has detected heat in the building, said processor being actuated to perform said alert sequence when said processor receives said heat alert;
a plurality of motion sensors, each motion sensor of said plurality of motion sensors being coupled to said dome wherein each motion sensor of said plurality of motion sensors is configured to sense motion in the building, each motion sensor of said plurality of motion sensors being in electrical communication with said processor, respective ones of said plurality of motion sensors communicating a motion alert to said processor when said respective ones of said plurality of motion sensors is actuated wherein said respective ones of said plurality of motion sensors is configured to alert said processor that said respective ones of said plurality of motion sensors has sensed motion in the building, said processor being actuated to perform said alert sequence when said processor receives said motion alert;
a camera being coupled to said dome wherein said camera is configured to capture imagery of the building, said camera being in electrical communication with said processor; and
a transceiver being coupled to said dome, said transceiver being in communication with said processor, said transceiver being actuated to broadcast an alert signal when said processor performs said alert sequence, said transceiver being in wireless communication with an extrinsic communication network wherein said transceiver is configured to communicate said alert signal to emergency responders such that the emergency responders can respond to a potential emergency in the building.

2. The robotic patrol device according to claim 1, further comprising:
said drive platform having a lower surface and an upper surface and a perimeter surface extending between said lower surface and said upper surface; and
said perimeter surface being continuously arcuate about a center of said drive platform such that said drive platform has a disk shape wherein said drive platform is configured to resist becoming entrapped in a corner of a building in which said drive platform is placed.

3. The robotic patrol device according to claim 2, further comprising:
each wheel of said plurality of wheels being disposed on said lower surface of said drive platform wherein said drive platform is configured to be supported above the support surface; and
said plurality of wheels being evenly spaced apart from each other and being distributed around a full circumference of said lower surface.

4. The robotic patrol device according to claim 1, wherein said plurality of motors rotates each wheel of said plurality of wheels independently of each other wherein said plurality of motors is configured to steer said drive platform in the building.

5. The robotic patrol device according to claim 1, further comprising:
said processor detecting when any of said plurality of motors encounter resistance to rotating; and
said processor actuating said plurality of motors to change direction of rotation when said processor detects that any of said plurality of motors encounters resistance to rotating wherein said plurality of motors is configured to drive said drive platform away from an obstacle in the building when said drive platform abuts against the obstacle.

6. The robotic patrol device according to claim 2, further comprising:
said dome having an outer wall;
said outer wall having a bottom edge;
said bottom edge being removably attachable to said upper surface of said drive platform; and
said outer wall curving upwardly from said upper surface of said drive platform when said bottom edge is removably attached to said upper surface of said drive platform.

7. The robotic patrol device according to claim 6, further comprising:
said outer wall having a planar portion extending upwardly from said bottom edge;
said outer wall having a curved portion extending between said planar portion and an apex of said dome; and
said planar portion angling inwardly between said bottom edge and said curved portion such that said dome has a frusto-conical shape.

8. The robotic patrol device according to claim 7, further comprising said smoke detector including an intake pipe being coupled to said curved portion of said outer wall of said dome.

9. The robotic patrol device according to claim 8, further comprising said intake pipe extending outwardly from said curved portion of said outer wall wherein said intake pipe is configured to be in fluid communication with ambient air in the building such that said smoke detector can detect smoke in the ambient air in the building.

10. The robotic patrol device according to claim 8, further comprising said intake pipe being located closer to said apex of said dome than said planar portion of said outer wall of said dome.

11. The robotic patrol device according to claim 2, further comprising:
said water detector including plurality of sensing lines; and
each sensing line of said plurality of sensing lines being coupled to and extending downwardly from said lower surface of said drive platform wherein each sensing line of said plurality of sensing lines is configured to be in physical contact with the support surface such that said plurality of sensing lines can sense when water is encountered on the support surface.

12. The robotic patrol device according to claim 7, further comprising said heat detector being integrated into said curved portion of said outer wall of said dome wherein said heat detector is configured to be in communication with the ambient air in the building.

13. The robotic patrol device according to claim 7, further comprising said plurality of motion sensors is arranged in a plurality of columns on said planar portion of said outer wall of said dome.

14. The robotic patrol device according to claim 13, further comprising each column of said plurality of columns extending along a line which extends between said curved portion of said dome and said bottom edge of said dome.

15. The robotic patrol device according to claim 13, further comprising said plurality of columns being evenly spaced apart from each other and being distributed around a full circumference of said planar portion of said outer wall.

16. The robotic patrol device according to claim 6, further comprising:
said camera including a stem having a bottom end being coupled to said outer wall of said dome; and
said stem being located on said apex of said dome.

17. The robotic patrol device according to claim 16, further comprising:
said stem having a top end;
said camera includes a housing having a bottom wall being coupled to said top end of said stem;
said housing having a front end and a back end; and
said housing being oriented such that a line extending between said front end and said back end is oriented parallel to said upper surface of said drive platform wherein said front end is configured to be directed toward an interior of the building.

18. The robotic patrol device according to claim 17, further comprising:
said camera including a lens being coupled to said front end of said housing wherein said lens is configured to pass light into said housing; and
said processor being in communication with said lens wherein said processor is configured to produce the imagery of said building from the light that passes through said lens.

19. The robotic patrol device according to claim 2, further comprising:
a power supply being coupled to said drive platform;
said power supply being in electrical communication with said processor, said power supply comprising:
a rechargeable battery being coupled to said upper surface of said drive platform, said rechargeable battery being in electrical communication with said processor; and
a charging port being coupled to said perimeter surface of said drive platform wherein said charging port is configured to be electrically mated with a charging dock, said charging port being in electrical communication with said rechargeable battery for charging said rechargeable battery.

20. A robotic patrol device for detecting smoke or water or intruders in an unoccupied building, said device comprising:
a drive platform;
a plurality of wheels, each wheel of said plurality of wheels being rotatably coupled to said drive platform wherein said plurality of wheels is configured to roll along a support surface, said drive platform having a lower surface and an upper surface and a perimeter surface extending between said lower surface and said upper surface, said perimeter surface being continuously arcuate about a center of said drive platform such that said drive platform has a disk shape wherein said drive platform is configured to resist becoming entrapped in a corner of a building in which said drive platform is placed, each wheel of said plurality of wheels being disposed on said lower surface of said drive platform wherein said drive platform is configured to be supported above the support surface, said plurality of wheels being evenly spaced apart from each other and being distributed around a full circumference of said lower surface;
a processor being coupled to said drive platform;
a plurality of motors, each motor of said plurality of motors being coupled to said drive platform, each motor of said plurality of motors being in electrical communication with said processor, each motor of said plurality of motors being in mechanical communication with a respective one of said plurality of wheels, a respective one of said plurality of motors rotating said respective one of said plurality of wheels when said respective one of said plurality of motors is turned on wherein said drive platform is configured to travel around the building, said plurality of motors rotating each wheel of said plurality of wheels independently of each other wherein said plurality of motors is configured to steer said drive platform in the building, said processor detecting when any of said plurality of motors encounter resistance to rotating, said processor actuating said plurality of motors to change direction of rotation when said processor detects that any of said plurality of motors encounters resistance to rotating wherein said plurality of motors is configured to drive said drive platform away from an obstacle in the building when said drive platform abuts against the obstacle;
a dome being removably coupled to said drive platform, said dome having an outer wall, said outer wall having a bottom edge, said bottom edge being removably attachable to said upper surface of said drive platform, said outer wall curving upwardly from said upper surface of said drive platform when said bottom edge is removably attached to said upper surface of said drive platform said outer wall having a planar portion extending upwardly from said bottom edge, said outer wall having a curved portion extending between said planar portion and an apex of said dome, said planar portion angling inwardly between said bottom edge and said curved portion such that said dome has a frusto-conical shape;
a smoke detector being coupled to said dome, said smoke detector being in electrical communication with said processor, said smoke detector communicating a smoke alert to said processor when said smoke detector is actuated wherein said smoke detector is configured to alert said processor that said smoke detector has detected smoke in the building, said processor being actuated to perform an alert sequence when said processor receives said smoke alert, said smoke detector including an intake pipe being coupled to said curved portion of said outer wall of said dome, said intake pipe extending outwardly from said curved portion of said outer wall wherein said intake pipe is configured to be in fluid communication with ambient air in the building such that said smoke detector can detect smoke in the ambient air in the building, said intake pipe being located closer to said apex of said dome than said planar portion of said outer wall of said dome;
a water detector being coupled to said drive platform, said water detector being in electrical communication with said processor, said water detector communicating a water alert to said processor when said water detector is actuated wherein said water detector is configured to alert said processor that said water detector has detected water in the building, said processor being actuated to perform said alert sequence when said processor receives said water alert, said water detector including plurality of sensing lines, each sensing line of said plurality of sensing lines being coupled to and extending downwardly from said lower surface of said drive platform wherein each sensing line of said plurality of sensing lines is configured to be in physical contact with the support surface such that said plurality of sensing lines can sense when water is encountered on the support surface;
a heat detector being coupled to said dome, said heat detector being in electrical communication with said processor, said heat detector communicating a heat alert to said processor when said heat detector is actuated wherein said heat detector is configured to alert said processor that said heat detector has detected heat in the building, said processor being actuated to perform said alert sequence when said processor receives said heat alert, said heat detector being integrated into said curved portion of said outer wall of said dome wherein said heat detector is configured to be in communication with the ambient air in the building;
a plurality of motion sensors, each motion sensor of said plurality of motion sensors being coupled to said dome wherein each motion sensor of said plurality of motion sensors is configured to sense motion in the building, each motion sensor of said plurality of motion sensors being in electrical communication with said processor, respective ones of said plurality of motion sensors communicating a motion alert to said processor when said respective ones of said plurality of motion sensors is actuated wherein said respective ones of said plurality of motion sensors is configured to alert said processor that said respective ones of said plurality of motion sensors has sensed motion in the building, said processor being actuated to perform said alert sequence when said processor receives said motion alert, said plurality of motion sensors being arranged in a plurality of columns on said planar portion of said outer wall of said dome, each column of said plurality of columns extending along a line which extends between said curved portion of said outer wall of said dome and said bottom edge of said dome, said plurality of columns being evenly spaced apart from each other and being distributed around a full circumference of said planar portion of said outer wall;
a camera being coupled to said dome wherein said camera is configured to capture imagery of the building, said camera being in electrical communication with said processor, said camera comprising:
a stem having a bottom end being coupled to said outer wall of said dome, said stem being located on said apex of said dome, said stem having a top end;
a housing having a bottom wall being coupled to said top end of said stem, said housing having a front end and a back end, said housing being oriented such that a line extending between said front end and said back end is oriented parallel to said upper surface of said drive platform wherein said front end is configured to be directed toward an interior of the building; and
a lens being coupled to said front end of said housing wherein said lens is configured to pass light into said housing, said processor being in communication with said lens wherein said processor is configured to receive the imagery of said building from the light that passes through said lens;
a transceiver being coupled to said dome, said transceiver being in communication with said processor, said transceiver being actuated to broadcast an alert signal when said processor performs said alert sequence, said transceiver being in wireless communication with an extrinsic communication network wherein said transceiver is configured to communicate said alert signal to emergency responders such that the emergency responders can respond to a potential emergency in the building; and
a power supply being coupled to said drive platform, said power supply being in electrical communication with said processor, said power supply comprising:
a rechargeable battery being coupled to said upper surface of said drive platform, said rechargeable battery being in electrical communication with said processor; and
a charging port being coupled to said perimeter surface of said drive platform wherein said charging port is configured to be electrically mated with a charging dock, said charging port being in electrical communication with said rechargeable battery for charging said rechargeable battery.
